(19) United States
(12) Patent Application Publication
(10) Pub. No.: US 2022/0188798 A1
(43) Pub. Date: Jun. 16, 2022

(54) CHECKOUT ASSISTANCE SYSTEM, CHECKOUT ASSISTANCE METHOD, AND PROGRAM

(71) Applicant: NEC Corporation, Minato-ku, Tokyo (JP)

(72) Inventor: Sae OKAWARA, Tokyo (JP)

(73) Assignee: NEC Corporation, Minato-ku, Tokyo (JP)

(21) Appl. No.: 17/599,018

(22) PCT Filed: Mar. 11, 2020
(86) PCT No.: PCT/JP2020/010455

§ 371 Date: Sep. 28, 2021

(30) Foreign Application Priority Data
Apr. 1, 2019 (JP) 2019-070070

(51) Int. Cl. G06Q 20/20

(52) U.S. Cl. CPC G06Q 20/208; G06Q 20/201

(57) ABSTRACT

A checkout assistance system (1) is configured by including a purchase product information generation unit (110) and a screen data generation unit (120). The purchase product information generation unit (110) generates purchase product information relating to a purchase product of a customer read by use of a mobile terminal (20) of the customer. Screen data including checkout processing information for causing a checkout processing apparatus that executes checkout processing to acquire the purchase product information are generated, and the screen data are output to a display apparatus (24) of the mobile terminal (20).

### TECHNICAL FIELD

The present invention relates to a technique for assisting checkout processing at a store.

### BACKGROUND ART

One example of a technique for assisting checkout processing at a store is disclosed in each of PTLs 1 and 2. PTL 1 discloses a technique for reading a purchase product with a mobile terminal of a customer, and displaying a total amount of the purchase product on the mobile terminal of the customer. Moreover, PTL 2 discloses, when a bargain product (discounted product) is purchased, issuing an electronic receipt including purchase information relating to the bargain product, and notifying a terminal of a customer of prediction information of a bargain product at a neighboring store, based on the electronic receipt.

### CITATION LIST

### Patent Literature

[PTL 1] Japanese Patent Application Publication No. 2012-018493

[PTL 2] International Patent Publication No. WO2017/183440

### SUMMARY OF INVENTION

### Technical Problem

PTLs 1 and 2 described above do not disclose a method of shortening a time required for checkout processing. When a time required for checkout processing at a store is long, there is a possibility of giving a negative influence on a satisfaction degree of a customer for the store. A technique for shortening a time required for checkout processing is desired.

The present invention has been made in view of the problem described above. One object of the present invention is to provide a technique for shortening a time required for checkout processing.

### Solution to Problem

A checkout assistance system according to the present invention includes:

a purchase product information generation unit that generates purchase product information at least including, as information relating to a purchase product of a customer, product identification information read by use of a mobile terminal; and

a screen data generation unit that generates screen data including checkout processing information for causing a checkout processing apparatus that executes checkout processing to acquire the purchase product information, and outputs the screen data to a display unit of the mobile terminal.

A checkout assistance method according to the present invention is

a checkout assistance method executed by at least one computer, and includes:

generating purchase product information at least including, as information relating to a purchase product of a customer, product identification information read by use of a mobile terminal; and

generating screen data including checkout processing information for causing a checkout processing apparatus that executes checkout processing to acquire the purchase product information, and outputting the screen data to a display unit of the mobile terminal.

A program according to the present invention causes a computer to execute the checkout assistance method described above.

### Advantageous Effects of Invention

The present invention enables shortening a time required for checkout processing.

### BRIEF DESCRIPTION OF DRAWINGS

FIG. 1 is a diagram illustrating a functional configuration of a checkout assistance system according to a first example embodiment.

FIG. 2 is a diagram illustrating a specific configuration of the checkout assistance system according to the first example embodiment.

FIG. 3 is a diagram illustrating hardware configurations of a store server and the checkout processing apparatus in FIG. 2.

FIG. 4 is a sequence diagram illustrating a flow of processing executed by a mobile terminal and the store server.

FIG. 5 is a diagram illustrating one example of a table storing information relating to a product.

FIG. 6 is a diagram illustrating one example of a table storing privilege information in association with product identification information.

FIG. 7 is a diagram illustrating one example of a screen displayed on a display apparatus of the mobile terminal, based on screen data generated by a screen data generation unit.

FIG. 8 is a diagram illustrating another example of a screen displayed on the display apparatus of the mobile terminal, based on screen data generated by the screen data generation unit.

FIG. 9 is a flowchart illustrating a flow of checkout processing executed by the checkout processing apparatus.

FIG. 10 is a diagram illustrating a modification example of a functional configuration of the checkout assistance system according to the first example embodiment.

FIG. 11 is a diagram illustrating one example of electronic receipt information generated by an electronic receipt information transmission unit.

FIG. 12 is a diagram illustrating a functional configuration of a checkout assistance system according to a second example embodiment.

FIG. 13 is a flowchart illustrating a flow of processing executed by a product image display processing unit according to the second example embodiment.

FIG. 14 is a diagram illustrating one example of information stored in a product image storage unit.

### EXAMPLE EMBODIMENT

Example embodiments according to the present invention are described below by use of the drawings. Note that, a similar reference sign is assigned to a similar component in all the drawings, and description is not repeated, as appropriate. Further, unless otherwise specially described, each block represents, in each block diagram, not a configuration on a hardware basis but a configuration on a function basis. Moreover, a direction of an arrow in the drawings serves for easy understanding of flow of information, and does not limit a direction of communication (one-way communication/two-way communication) unless otherwise specially described.

### First Example Embodiment

### Functional Configuration Example

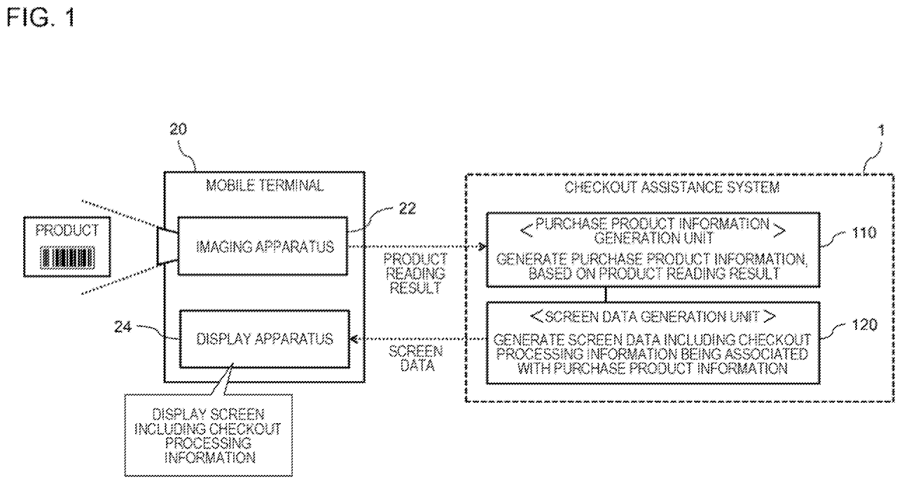

FIG. 1 is a diagram illustrating a functional configuration of a checkout assistance system 1 according to a first example embodiment. The checkout assistance system 1 according to the present example embodiment is configured by including a purchase product information generation unit 110 and a screen data generation unit 120.

First, a customer reads a product intended to be purchased, by use of an imaging apparatus 22 mounted in a mobile terminal 20 (e.g., a smartphone, a tablet terminal, or the like). The purchase product information generation unit 110 generates information (hereinafter, also referred to as “purchase product information”) relating to a purchase product of the customer, based on a reading result of the product by the mobile terminal 20. The screen data generation unit 120 generates data of a screen including checkout processing information being associated with the purchase product information. The checkout processing information is information that is read by a checkout processing apparatus (not illustrated) executing checkout processing and thereby causes the checkout processing apparatus to acquire the purchase product information described above. Moreover, the screen data generation unit 120 transmits the generated screen data to the mobile terminal 20. The mobile terminal 20 outputs, to a display apparatus 24 thereof, a screen including the checkout processing information, based on the screen data acquired from the screen data generation unit 120.

Each of the functional units described above (the purchase product information generation unit 110 and the screen data generation unit 120) is stored in a storage device or the like of at least one computer, as a program module. Then, a processor mounted in the computer reads each of the program modules, executes the read program module, and thereby achieves a function being associated with each of the modules.

### Advantageous Effect

As above, according to the present example embodiment, a reading operation (registration operation) of a purchase product is executed by the mobile terminal 20 of a customer, and, thereafter, a screen including checkout processing information for causing a non-illustrated checkout processing apparatus to acquire information of the purchase product is displayed on the display apparatus 24 of the mobile terminal 20. The non-illustrated checkout processing apparatus reads the checkout processing information included in the screen displayed on the display apparatus 24 of the mobile terminal 20, and, thereby, can acquire purchase product information being associated with the checkout processing information. Then, the non-illustrated checkout processing apparatus can recognize a product to be purchased by a customer, and execute checkout processing, based on the acquired purchase product information. The present example embodiment eliminates a need to perform an operation of reading each purchase product of a customer, in a checkout processing apparatus that executes checkout processing of a product. As a result, an effect of shortening a time required for checkout processing is obtained.

### Specific Example

A more specific configuration is illustrated below regarding the checkout assistance system 1 according to the present example embodiment.

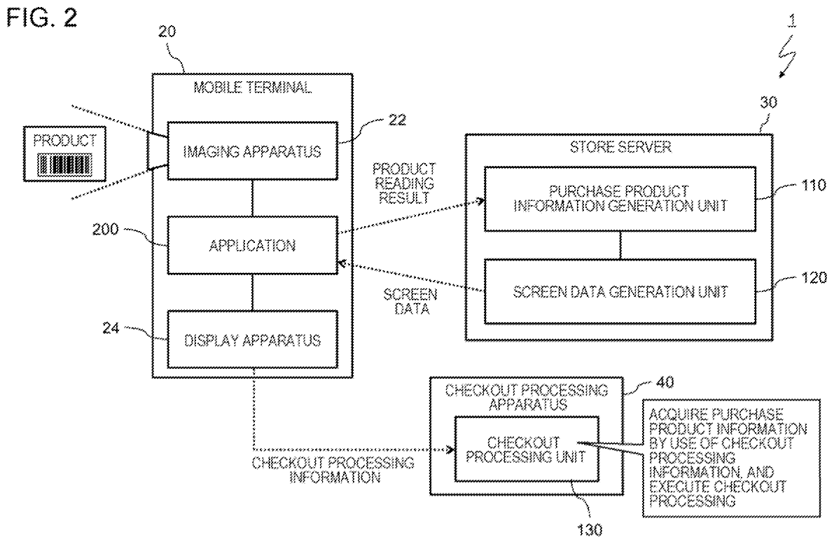

FIG. 2 is a diagram illustrating a specific configuration of the checkout assistance system 1 according to the first example embodiment. The checkout assistance system 1 illustrated in FIG. 2 is configured by including the mobile terminal 20, a store server 30, and a checkout processing apparatus 40. Note that, although not illustrated in order to simplify the drawing, a plurality of the checkout processing apparatuses 40 can exist in the checkout assistance system 1.

In the example in FIG. 2, the purchase product information generation unit 110 and the screen data generation unit 120 described above are included in the store server 30. In the example in the present drawing, the purchase product information generation unit 110 acquires a reading result of a product from a dedicated application 200 installed on the mobile terminal 20 (e.g., a smartphone, a tablet terminal, or the like) owned by a customer, and generates purchase product information relating to a product to be purchased by the customer. The application 200 reads a product intended to be purchased by a customer, by use of a camera function (the imaging apparatus 22) of the mobile terminal 20. Specifically, the application 200 acquires an image (e.g., an appearance image of a product, an image of a barcode portion, or the like) used to identify the purchase product of a customer. The purchase product information generation unit 110 identifies a purchase product of a customer by processing the image acquired by the application 200, and generates information (purchase product information) indicating a purchase product for each customer. The purchase product information generation unit 110 stores the purchase product information for each customer in a predetermined storage area (such as a storage device of the store server 30).

The screen data generation unit 120 generates data of a screen including information (checkout processing information) utilized in order to cause the checkout processing apparatus that executes checkout processing of a product to acquire the purchase product information described above. As one example, the screen data generation unit 120 generates screen data of a screen including, as checkout processing information, a code symbol (ex: a barcode) encoding information (e.g., an ID allocated to each piece of purchase product information, or the like) that can uniquely determine target purchase product information. As another example, the screen data generation unit 120 may be configured in such a way as to generate screen data of a screen including, as checkout processing information, a code symbol (ex: a two-dimensional code) encoding purchase product information itself for each customer. The screen data generation unit 120 transmits the generated screen data to the mobile terminal 20. The application 200 operating on the mobile terminal 20 causes the display apparatus 24 to display the screen including the checkout processing information, based on the screen data acquired from the screen data generation unit 120.

In the example in FIG. 2, the checkout processing apparatus 40 includes a checkout processing unit 130. The checkout processing unit 130 reads the checkout processing information included in the screen displayed on the display apparatus 24 of the mobile terminal 20, and thereby acquires purchase product information being associated with the checkout processing information. Moreover, the checkout processing unit 130 executes checkout processing, based on the purchase product information acquired by use of the checkout processing information.

### Hardware Configuration Example

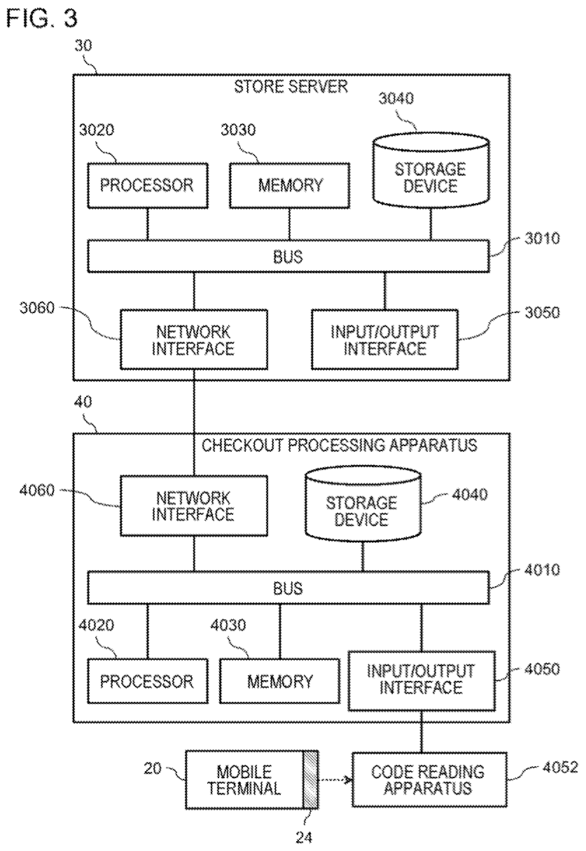

FIG. 3 is a diagram illustrating hardware configurations of the store server 30 and the checkout processing apparatus 40 in FIG. 2.

The store server 30 includes a bus 3010, a processor 3020, a memory 3030, a storage device 3040, an input/output interface 3050, and a network interface 3060.

The bus 3010 is a data transmission path through which the processor 3020, the memory 3030, the storage device 3040, the input/output interface 3050, and the network interface 3060 transmit/receive data to/from each other. However, a method of mutually connecting the processor 3020 and the like is not limited to bus connection.

The processor 3020 is a processor achieved by a central processing unit (CPU), a graphics processing unit (GPU), or the like.

The memory 3030 is a main storage achieved by a random access memory (RAM) or the like.

The storage device 3040 is an auxiliary storage achieved by a hard disk drive (HDD), a solid state drive (SSD), a memory card, a read only memory (ROM), or the like. The storage device 3040 stores a program module that achieves each function (the purchase product information generation unit 110, the screen data generation unit 120, or the like) of the store server 30. The processor 3020 reads each of the program modules onto the memory 3030, executes the read program module, and thereby achieves a function of the purchase product information generation unit 110 and a function of the screen data generation unit 120.

The input/output interface 3050 is an interface for connecting the store server 30 to peripheral equipment. Although not illustrated, input equipment such as a keyboard or a mouse, a display (touch panel display), a speaker, and the like are connectable to the input/output interface 3050.

The network interface 3060 is an interface for connecting the store server 30 to a network. The network is, for example, a local area network (LAN) or a wide area network (WAN). A method of connecting the network interface 3060 to a network may be wireless connection or may be wired connection. The store server 30 is communicably connected to an external apparatus such as the mobile terminal 20 and the checkout processing apparatus 40 via the network interface 3060. The purchase product information generation unit 110 can acquire, via the network interface 3060, processing information (a product image or the like) of the application 200 installed on the mobile terminal 20.

Similarly to the store server 30, the checkout processing apparatus 40 also includes a bus 4010, a processor 4020, a memory 4030, a storage device 4040, an input/output interface 4050, and a network interface 4060. The storage device 4040 of the checkout processing apparatus 40 stores a program module that achieves each function (the checkout processing unit 130 or the like) of the checkout processing apparatus 40. The processor 4020 reads each of the program modules onto the memory 4030, executes the read program module, and thereby achieves a function of the checkout processing unit 130 described above. As illustrated, the checkout processing unit 130 can read checkout processing information displayed on the display apparatus 24 of the mobile terminal 20, via a code reading apparatus 4052 connected to the input/output interface 4050. When checkout processing information is a code symbol encoding purchase product information itself, the checkout processing unit 130 can acquire the purchase product information by use of the code reading apparatus 4052. Moreover, when checkout processing information is a code symbol encoding identification information uniquely indicating purchase product information, the checkout processing unit 130 transmits the checkout processing information to the store server 30 via the network interface 4060. Then, the checkout processing unit 130 can acquire purchase product information being associated with the checkout processing information from the store server 30 via the network interface 4060.

Note that, the configuration illustrated in FIG. 3 is only one example, and the hardware configurations of the store server 30 and the checkout processing apparatus 40 are not limited to the example in FIG. 3.

<Flow of Processing>

A flow of processing according to the present example embodiment is described by use of a drawing.

<<Processing Between Mobile Terminal 20 and Store Server 30>>

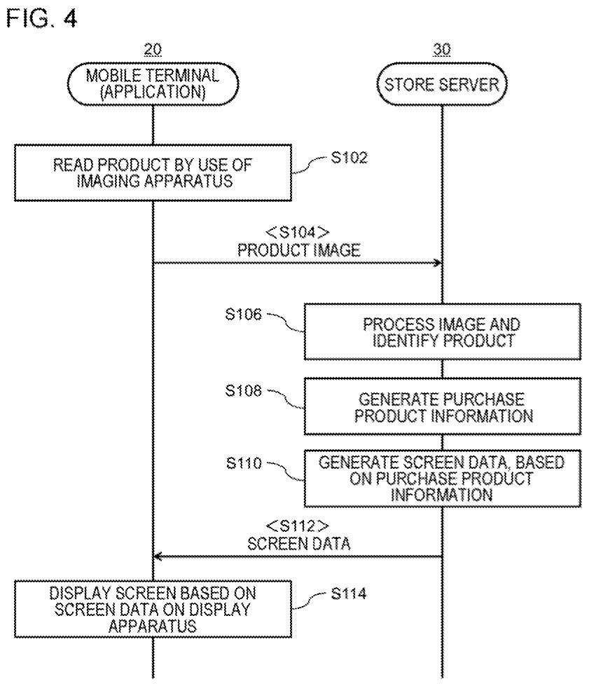

FIG. 4 is a sequence diagram illustrating a flow of processing executed by the mobile terminal 20 and the store server 30.

First, a customer reads a product intended to be purchased, by use of the application 200 (S102). For example, a customer previously starts the application 200 on the mobile terminal 20, and captures a product by use of the camera function (the imaging apparatus 22) of the mobile terminal 20 when putting the product intended to be purchased in a shopping basket. The application 200 transmits, to the store server 30, a product image generated by the imaging apparatus 22 (S104).

The purchase product information generation unit 110 processes the product image acquired from the application 200, and identifies the product in the image (S106). As one example, the purchase product information generation unit 110 is configured in such a way as to identify a product in an image by use of a classifier configured to be capable of identifying each product by machine learning. As another example, the purchase product information generation unit 110 may be configured in such a way as to identify a product in an image by collating feature data extractable from the image with appearance feature data of each previously registered product. Herein, “identifying a product” means acquiring information (e.g., identification information or the like of the product, such as Japan article number (JAN)) uniquely indicating the product. Note that, processing of identifying a product from a product image may be executed on the application 200 side. In this case, the application 200 is mounted with a function of identifying a product from a product image.

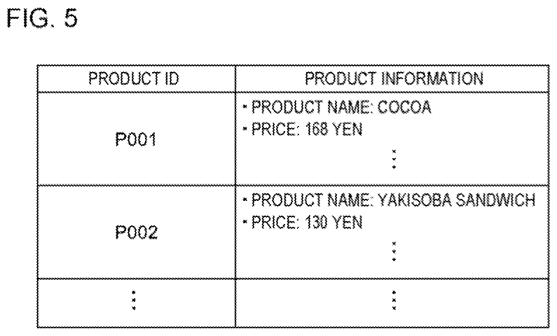

Then, the purchase product information generation unit 110 generates purchase product information, based on an identification result of the product (identification information of the product) (S108). The purchase product information generation unit 110 acquires information used when generating purchase product information, with reference to, for example, a table as illustrated in FIG. 5. FIG. 5 is a diagram illustrating one example of a table storing information relating to a product. The table illustrated in FIG. 5 stores various kinds of information (e.g., a name or a unit price of a product) relating to the product in association with identification information of the product. The table illustrated in FIG. 5 is stored, for example, on the storage device 3040 of the store server 30. The purchase product information generation unit 110 can acquire information being associated with the identification information of the product acquired in the processing of S106, and information used when generating purchase product information, from the table illustrated in FIG. 5. Then, the purchase product information generation unit 110 generates purchase product information by use of the acquired information.

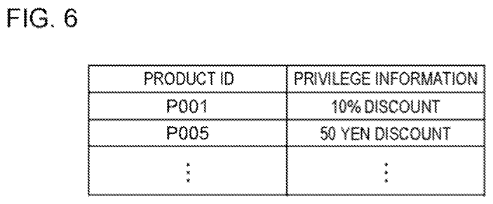

Herein, a product sold at a store may be given a privilege such as a reduction or a discount. The purchase product information generation unit 110 may be configured in such a way as to acquire privilege information (information of a reduction rate or a discount amount) being associated with a purchase product read by use of the application 200, when generating purchase product information. As a specific example, the purchase product information generation unit 110 refers to a table as illustrated in FIG. 6, and, when there is privilege information being associated with a product read by use of the application 200, acquires the privilege information. FIG. 6 is a diagram illustrating one example of a table storing privilege information in association with product identification information. The table illustrated in FIG. 6 is stored, for example, on the storage device 3040 of the store server 30. When privilege information can be acquired, the purchase product information generation unit 110 generates purchase product information further by use of the privilege information. For example, regarding a product for which privilege information exists, the purchase product information generation unit 110 corrects a price of the product, based on a privilege (a reduction rate or a discount amount) indicated by the privilege information. Then, the purchase product information generation unit 110 generates purchase product information, based on a price after the privilege is applied. The purchase product information generation unit 110 stores, in a storage area such as the storage device 3040, the generated purchase product information, in association with customer determination information (e.g., a user ID allocated to a user of the application 200, or the like) determining a customer who purchases a product.

The screen data generation unit 120 generates screen data of a screen that the display apparatus 24 of the mobile terminal 20 is caused to display, based on the purchase product information generated in the processing of S108 (S110). For example, the screen data generation unit 120 is configured in such a way as to generate screen data of a screen including, as checkout processing information, a code symbol encoding the purchase product information. As a specific example, the screen data generation unit 120 generates a one-dimensional code symbol encoding identification information (e.g., an ID given to each piece of purchase product information, or the like) uniquely indicating purchase product information of each customer stored in a storage area such as the storage device 3040, and generates screen data of a screen including the one-dimensional code symbol as checkout processing information. As another example, the screen data generation unit 120 may be configured in such a way as to generate screen data of a screen including, as checkout processing information, a two-dimensional code symbol encoding purchase product information itself of each customer.

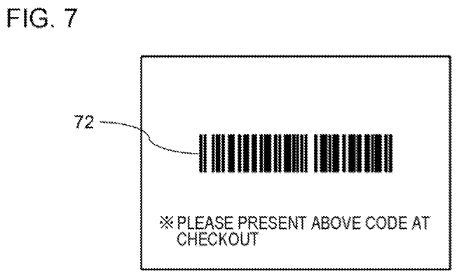

Then, the screen data generation unit 120 transmits the generated screen data to the mobile terminal 20 (S112). Herein, the screen data generation unit 120 can determine the mobile terminal 20 to be a transmission destination of screen data, based on customer determination information being associated with purchase product information. As one example, the screen data generation unit 120 determines destination information of the mobile terminal 20 to be a transmission destination of screen data, by use of a list (not illustrated) indicating association relation between customer determination information and the destination information of the mobile terminal 20, and transmits the screen data by use of the destination information. Note that, a list indicating an association relation between customer determination information and destination information of the mobile terminal 20 can be previously generated, based on, for example, information input in each terminal at installation of the application 200. When acquiring screen data generated by the screen data generation unit 120, the mobile terminal 20 (application 200) displays a screen based on the screen data (ex: FIG. 7), on the display apparatus 24 of the mobile terminal 20 (S114).

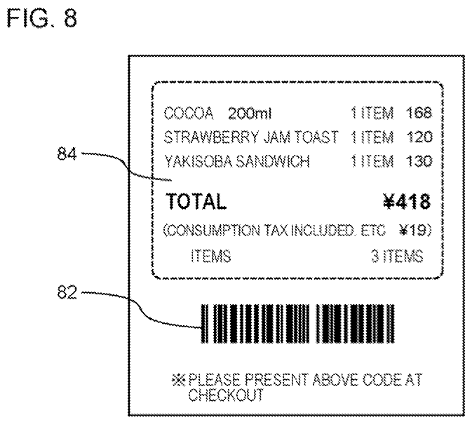

FIG. 7 is a diagram illustrating one example of a screen displayed on the display apparatus 24 of the mobile terminal 20, based on screen data generated by the screen data generation unit 120. The screen illustrated in the present drawing has a one-dimensional code symbol 72 encoding checkout processing information. Herein, the screen data generation unit 120 may be configured in such a way as to generate, based on purchase product information, screen data of a screen (ex: FIG. 8) further including information of a purchase product and a price of the purchase product. FIG. 8 is a diagram illustrating another example of a screen displayed on the display apparatus 24 of the mobile terminal 20, based on screen data generated by the screen data generation unit 120. The screen illustrated in the present drawing includes information 84 such as names, the number, prices, and a total amount of purchase products, together with a code symbol 82 encoding checkout processing information. Displaying the screen as illustrated in FIG. 8 on the display apparatus 24 allows a customer owning the mobile terminal 20 to easily recognize whether there is no mistake in a product registered as a purchase product. Moreover, displaying the screen as illustrated in FIG. 8 on the display apparatus 24 allows a customer owning the mobile terminal 20 to easily recognize whether a total amount of products intended to be purchased is within a budget.

Note that, the screen data generation unit 120 may be configured in such a way as to update screen data each time a product is read by the mobile terminal 20, and output updated screen data to the mobile terminal 20. Moreover, the screen data generation unit 120 may be configured in such a way as to output, when acquiring information indicating that an operation of ending registration of a purchase product is executed on the mobile terminal 20, screen data of a screen including checkout processing information to the mobile terminal 20, in response to acquisition of the information. In a latter case, for example, the application 200 installed on the mobile terminal 20 displays, on the mobile terminal 20, a screen including a button pressed at end of product registration, or the like. When a customer presses the button displayed on the screen, the application 200 transmits, to the store server 30 (screen data generation unit 120), information indicating that the button is pressed (i.e., an operation of ending registration of a purchase product is executed). When acquiring the information indicating that the operation of ending registration of a purchase product is executed, the screen data generation unit 120 transmits, to the mobile terminal 20, screen data generated based on purchase product information.

Herein, for example, as in a limited-time sale, a new privilege may be added to a purchase product read by the application 200. In order to cope with such a case, the purchase product information generation unit 110 may be configured in such a way as to update, when privilege information is newly added regarding a purchase product of a customer, purchase product information by use of the newly added privilege information. For example, when a manager of the store server 30 executes an operation of adding new privilege information to a table as illustrated in FIG. 5, a notification notifying that the new privilege information is added is transmitted to the purchase product information generation unit 110. The purchase product information generation unit 110 refers to the table in response to the notification, and determines whether the new privilege information is given to a product indicated by purchase product information stored in the storage device 3040 or the like. Herein, when new privilege information is detected, the purchase product information generation unit 110 updates, by use of the new privilege information, the purchase product information stored in the storage device 3040 or the like. This can prevent occurrence of such a problem that a privilege is not appropriately given in such a case that the privilege is given later as in a limited-time sale.

<<Checkout Processing>>

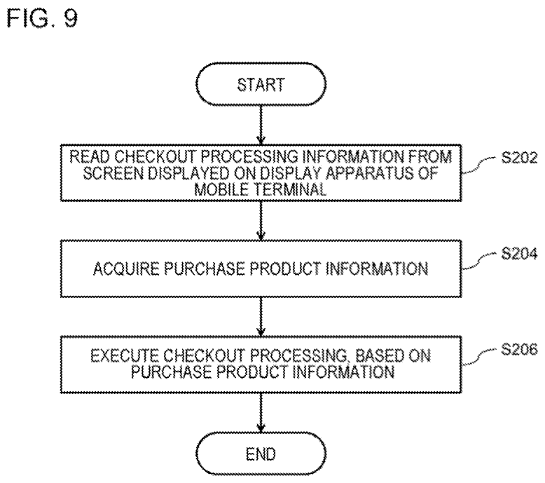

FIG. 9 is a flowchart illustrating a flow of checkout processing executed by the checkout processing apparatus 40.

First, the checkout processing unit 130 reads checkout processing information from a screen displayed on the display apparatus 24 of the mobile terminal 20 (S202). Then, the checkout processing unit 130 acquires purchase product information by use of the read checkout processing information (S204). For example, when a screen including, as checkout processing information, a one-dimensional code symbol encoding identification information being associated with purchase product information stored on the store server 30 is displayed on the display apparatus 24 of the mobile terminal 20, the checkout processing unit 130 acquires the purchase product information from the store server 30, by use of identification information acquired by reading the code symbol. Moreover, when a screen including, as checkout processing information, a two-dimensional code symbol encoding purchase product information itself is displayed on the display apparatus 24 of the mobile terminal 20, the checkout processing unit 130 can acquire the purchase product information by reading the code symbol. Then, the checkout processing unit 130 executes checkout processing of the product, based on the acquired purchase product information (S206). In this way, in the checkout processing apparatus 40, a purchase product of a customer is registered by reading checkout processing information from a screen displayed on the display apparatus 24 of the mobile terminal 20. This can omit a process of sequentially reading a purchase product of a customer in the checkout processing apparatus 40, and shorten a time required for checkout processing.

### Modification Example

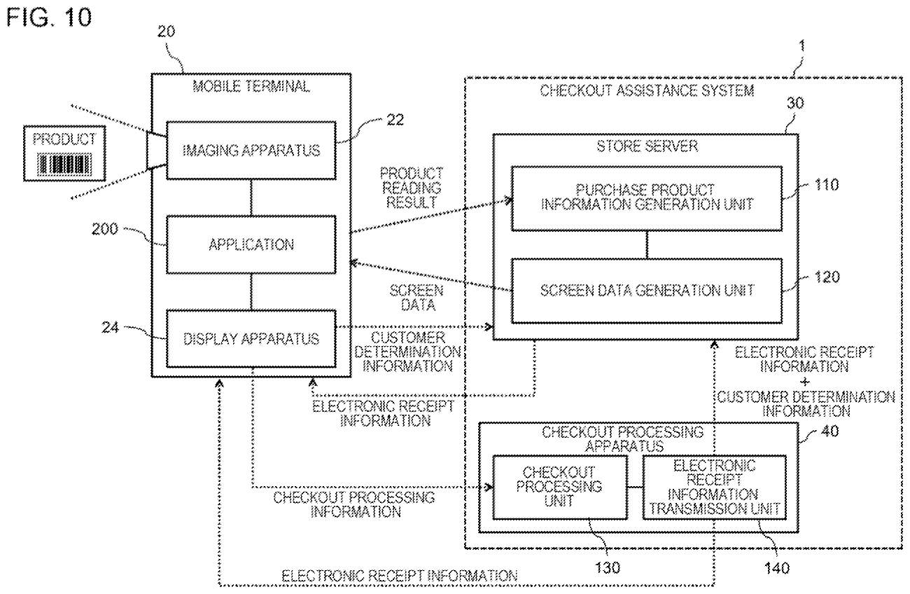

FIG. 10 is a diagram illustrating a modification example of a functional configuration of the checkout assistance system 1 according to the first example embodiment. The checkout assistance system 1 according to the present modification example further includes an electronic receipt information transmission unit 140 that transmits an electronic receipt. The electronic receipt information transmission unit 140 transmits electronic receipt information based on purchase product information to the mobile terminal 20, in response to completion of checkout processing in the checkout processing unit 130. The electronic receipt information transmission unit 140 is further included in, for example, the checkout processing apparatus 40 in FIG. 2.

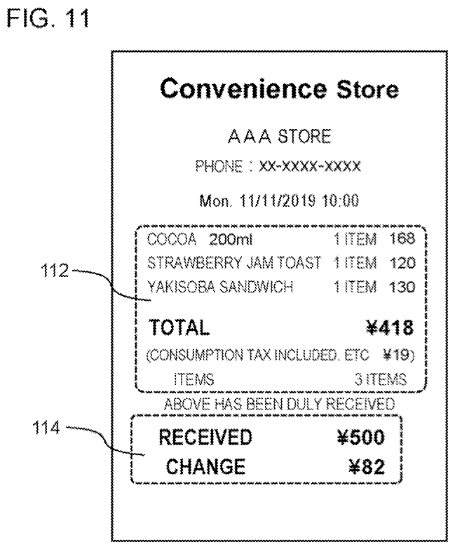

For example, the electronic receipt information transmission unit 140 generates electronic receipt information as illustrated in FIG. 11, by use of checkout processing in the checkout processing unit 130, and purchase product information. FIG. 11 is a diagram illustrating one example of electronic receipt information generated by the electronic receipt information transmission unit 140. Data 112 of a part pertaining to a purchase product in FIG. 11 are generated based on purchase product information used in checkout processing. Moreover, data 114 of a part relating to a deposit or a change in FIG. 11 are generated based on information input to the checkout processing apparatus 40 in checkout processing. The electronic receipt information transmission unit 140 determines destination information of the mobile terminal 20 to be a transmission destination of electronic receipt information, based on customer determination information being associated with purchase product information used in checkout processing. Then, the electronic receipt information transmission unit 140 transmits electronic receipt information to the target mobile terminal 20, by use of the destination information. Moreover, the electronic receipt information transmission unit 140 may be configured in such a way as to store generated electronic receipt data in a predetermined storage area (e.g., the storage device 3040 of the store server 30 or the like) in association with customer determination information being linked with purchase product information used in checkout processing. In this case, a customer can download electronic receipt information stored in the store server 30 onto the mobile terminal 20 of the customer, by using customer identification information of the customer and accessing the non-illustrated store server 30, and confirm a content of the electronic receipt information.

### Second Example Embodiment

Herein, in order to avoid an unnecessary trouble, it is preferable to include a function of checking, at checkout, a purchase product read by a mobile terminal 20. A checkout assistance system 1 according to the present example embodiment differs from that of the example embodiment described above, in further including a function, as described below, of checking, at checkout, a purchase product read by the mobile terminal 20.

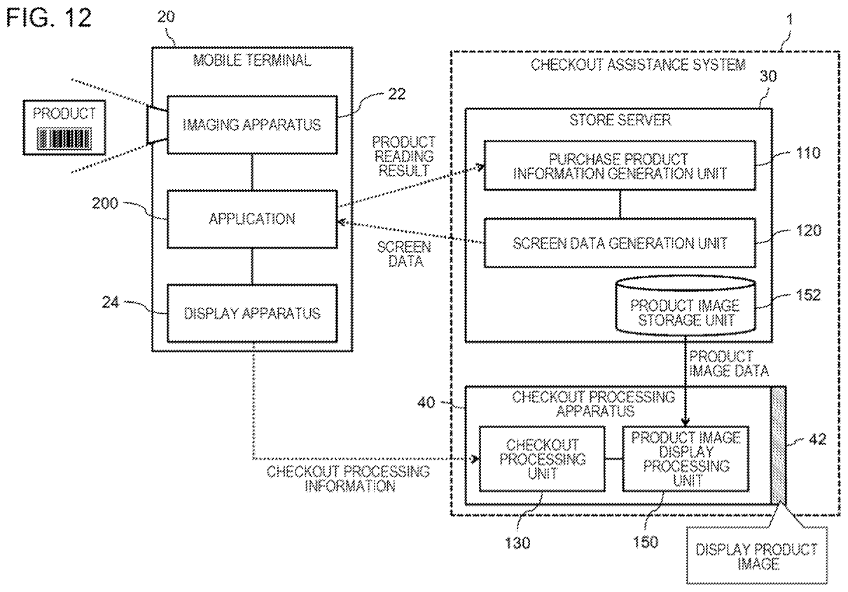

FIG. 12 is a diagram illustrating a functional configuration of the checkout assistance system 1 according to a second example embodiment. As illustrated in FIG. 12, the checkout assistance system 1 according to the present example embodiment further includes a product image display processing unit 150. In the example in FIG. 12, the product image display processing unit 150 is included in a checkout processing apparatus 40. The product image display processing unit 150 acquires, regarding purchase product information acquired by use of checkout processing information, product image data (e.g., image data acquired by capturing a product from a front or a side thereof) used for confirmation of a purchase product indicated by the purchase product information. For example, the product image display processing unit 150 can acquire product image data being associated with a purchase product indicated by the purchase product information, from a product image storage unit 152 that stores product image data of each product. Then, the product image display processing unit 150 outputs the acquired product image data to a display apparatus 42 of the checkout processing apparatus 40.

<Flow of Processing>

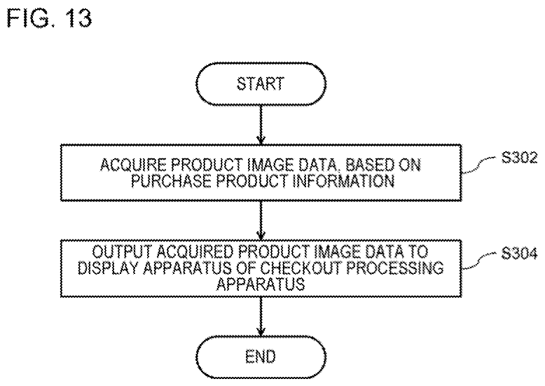

A flow of processing executed by the product image display processing unit 150 according to the present example embodiment is described by use of a drawing. FIG. 13 is a flowchart illustrating a flow of processing executed by the product image display processing unit 150 according to the second example embodiment.

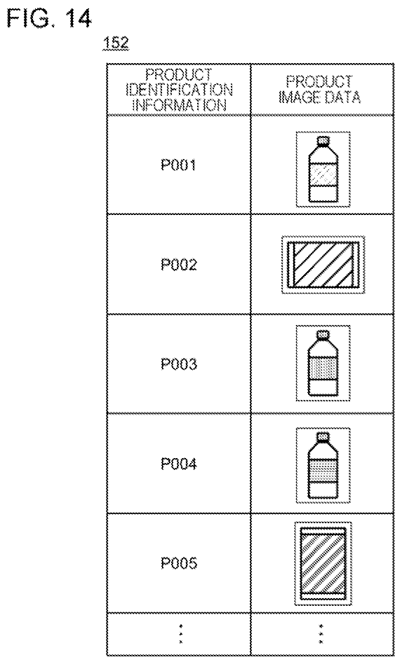

The product image display processing unit 150 acquires, by use of purchase product information acquired in the processing in S204 of FIG. 9, product image data of a product indicated by the purchase product information (S302). For example, it is assumed that information as illustrated in FIG. 14 is stored in the product image storage unit 152. FIG. 14 is a diagram illustrating one example of information stored in the product image storage unit 152. Then, regarding purchase product information acquired in the processing in S204 of FIG. 9, the product image display processing unit 150 acquires pieces of product image data of first and fifth rows of FIG. 14 when products indicated by the purchase product information are a product of “P001” and a product of “P005”. Then, the product image display processing unit 150 outputs the product image data acquired in the processing in S302 to the display apparatus 42 of the checkout processing apparatus 40 (S304).

According to the present example embodiment, when checkout processing is performed in the checkout processing apparatus 40, image data of a product intended to be purchased, previously read by use of the mobile terminal 20, are displayed on the display apparatus 42 of the checkout processing apparatus 40. The configuration according to the present example embodiment enables a customer or a clerk to easily determine whether a reading result of a product in the mobile terminal 20 matches a product brought into an installation place of the checkout processing apparatus 40 (whether there is no registration mistake or registration failure of a product).

While the example embodiments of the present invention have been described above with reference to the drawings, the present invention should not be limited to the example embodiments and interpreted, and various changes, improvements, and the like can be made, based on knowledge of a person skilled in the art, without departing from the spirit of the present invention. A plurality of components disclosed in the example embodiments can form various inventions by a suitable combination of the components. For example, some of all components disclosed in the example embodiments may be deleted, or components in differing example embodiments may be suitably combined.

Moreover, although a plurality of processes (pieces of processing) are described in order in a plurality of sequence diagrams and flowcharts used in the above description, an execution order of processes executed in each example embodiment is not limited to the described order. In each example embodiment, an order of illustrated processes can be changed to an extent that causes no problem in terms of content.

Some or all of the above-described example embodiments can also be described as, but not limited to, the following supplementary notes.

1. A checkout assistance system including:

a purchase product information generation unit that generates purchase product information relating to a purchase product of a customer read by use of a mobile terminal of the customer; and

a screen data generation unit that generates screen data including checkout processing information for causing a checkout processing apparatus that executes checkout processing to acquire the purchase product information, and outputs the screen data to a display unit of the mobile terminal.

2. The checkout assistance system according to supplementary note 1, wherein

the screen data generation unit outputs, to a screen of the mobile terminal, the screen data in response to acquisition of information indicating that an operation of ending registration of the purchase product is executed on the mobile terminal.

3. The checkout assistance system according to supplementary note 1 or 2, wherein

the purchase product information generation unit acquires privilege information being associated with the purchase product, and generates the purchase product information further by use of the privilege information.

4. The checkout assistance system according to supplementary note 3, wherein

the purchase product information generation unit updates, when the privilege information is newly added regarding the purchase product, the purchase product information by use of the newly added privilege information.

5. The checkout assistance system according to any one of supplementary notes 1 to 4, wherein

the screen data generation unit generates the screen data further including information of the purchase product and a price of the purchase product.

6. The checkout assistance system according to any one of supplementary notes 1 to 5, further including

a checkout processing unit that executes checkout processing, based on the purchase product information acquired by use of the checkout processing information.

7. The checkout assistance system according to supplementary note 6, further including

a product image display processing unit that acquires product image data of the purchase product indicated by the purchase product information acquired by use of the checkout processing information, and outputs the product image data onto a screen of the checkout processing apparatus.

8. The checkout assistance system according to supplementary note 6 or 7, further including

an electronic receipt information transmission unit that transmits electronic receipt information based on the purchase product information to the mobile terminal, in response to completion of the checkout processing.

9. The checkout assistance system according to any one of supplementary notes 1 to 8, wherein

the screen data generation unit generates screen data including, as the checkout processing information, a code symbol encoding the purchase product information.

10. A checkout assistance method executed by at least one computer, including:

generating purchase product information relating to a purchase product of a customer read by use of a mobile terminal of the customer; and

generating screen data including checkout processing information for causing a checkout processing apparatus that executes checkout processing to acquire the purchase product information, and outputting the screen data to a display unit of the mobile terminal.

11. The checkout assistance method executed by the computer according to supplementary note 10, further including,

outputting, to a screen of the mobile terminal, the screen data in response to acquisition of information indicating that an operation of ending registration of the purchase product is executed on the mobile terminal.

12. The checkout assistance method executed by the computer according to supplementary note 10 or 11, further including,

acquiring privilege information being associated with the purchase product, and generating the purchase product information further by use of the privilege information.

13. The checkout assistance method executed by the computer according to supplementary note 12, further including,

updating, when the privilege information is newly added regarding the purchase product, the purchase product information by use of the newly added privilege information.

14. The checkout assistance method executed by the computer according to any one of supplementary notes 10 to 13, further including,

generating the screen data further including information of the purchase product and a price of the purchase product.

15. The checkout assistance method executed by the computer according to any one of supplementary notes 10 to 14, further including,

executing checkout processing, based on the purchase product information acquired by use of the checkout processing information.

16. The checkout assistance method executed by the computer according to supplementary note 15, further including,

acquiring product image data of the purchase product indicated by the purchase product information acquired by use of the checkout processing information, and outputting the product image data onto a screen of the checkout processing apparatus.

17. The checkout assistance method executed by the computer according to supplementary note 15 or 16, further including,

transmitting electronic receipt information based on the purchase product information to the mobile terminal, in response to completion of the checkout processing.

18. The checkout assistance method executed by the computer according to any one of supplementary notes 10 to 17, further including,

generating screen data including, as the checkout processing information, a code symbol encoding the purchase product information.

19. A program that causes a computer to execute the checkout assistance method according to any one of supplementary notes 10 to 18.

This application is based upon and claims the benefit of priority from Japanese Patent Application No. 2019-070070, filed on Apr. 1, 2019, the disclosure of which is incorporated herein in its entirety by reference.

### REFERENCE SIGNS LIST

1 Checkout assistance system
110 Purchase product information generation unit
120 Screen data generation unit
130 Checkout processing unit
140 Electronic receipt information transmission unit
150 Product image display processing unit
152 Product image storage unit
20 Mobile terminal
22 Imaging apparatus
24 Display apparatus
200 Application
30 Store server
3010 Bus
3020 Processor
3030 Memory
3040 Storage device
3050 Input/output interface
3060 Network interface
40 Checkout processing apparatus
4010 Bus
4020 Processor
4030 Memory
4040 Storage device
4050 Input/output interface
4052 Code reading apparatus
4060 Network interface
42 Display apparatus

1. A checkout assistance system comprising:
a memory storing instructions; and
a processor configured to execute the instructions to perform:
generating purchase product information relating to a purchase product of a customer read by use of a mobile terminal of the customer;
generating screen data including checkout processing information for causing a checkout processing apparatus that executes checkout processing to acquire the purchase product information; and
outputting the screen data to a display of the mobile terminal.

2. The checkout assistance system according to claim 1, wherein
the processor is further configured to execute the instructions to perform outputting, to a screen of the mobile terminal, the screen data in response to acquisition of information indicating that an operation of ending registration of the purchase product is executed on the mobile terminal.

3. The checkout assistance system according to claim 1, wherein the processor is further configured to execute the instructions to perform:
acquiring privilege information being associated with the purchase product; and
generating the purchase product information further by use of the privilege information.

4. The checkout assistance system according to claim 3, wherein
the processor is further configured to execute the instructions to perform updating, when the privilege information is newly added regarding the purchase product, the purchase product information by use of the newly added privilege information.

5. The checkout assistance system according to claim 1, wherein
the processor is further configured to execute the instructions to perform generating the screen data further including information of the purchase product and a price of the purchase product.

6. The checkout assistance system according to claim 1, wherein
the processor is further configured to execute the instructions to perform executing checkout processing, based on the purchase product information acquired by use of the checkout processing information.

7. The checkout assistance system according to claim 6, wherein the processor is further configured to execute the instructions to perform:
acquiring product image data of the purchase product indicated by the purchase product information acquired by use of the checkout processing information; and
outputting the product image data onto a screen of the checkout processing apparatus.

8. The checkout assistance system according to claim 6, wherein
the processor is further configured to execute the instructions to perform transmitting electronic receipt information based on the purchase product information to the mobile terminal, in response to completion of the checkout processing.

9. The checkout assistance system according to claim 1, wherein
the processor is further configured to execute the instructions to perform generating screen data including, as the checkout processing information, a code symbol encoding the purchase product information.

10. A checkout assistance method executed by at least one computer, comprising:
generating purchase product information relating to a purchase product of a customer read by use of a mobile terminal of the customer;
generating screen data including checkout processing information for causing a checkout processing apparatus that executes checkout processing to acquire the purchase product information; and
outputting the screen data to a display of the mobile terminal.

11. The checkout assistance method executed by the computer according to claim 10, further comprising,
outputting, to a screen of the mobile terminal, the screen data in response to acquisition of information indicating that an operation of ending registration of the purchase product is executed on the mobile terminal.

12. The checkout assistance method executed by the computer according to claim 10, further comprising,
acquiring privilege information being associated with the purchase product, and generating the purchase product information further by use of the privilege information.

13. The checkout assistance method executed by the computer according to claim 12, further comprising,
updating, when the privilege information is newly added regarding the purchase product, the purchase product information by use of the newly added privilege information.

14. The checkout assistance method executed by the computer according to claim 10, further comprising,
generating the screen data further including information of the purchase product and a price of the purchase product.

15. The checkout assistance method executed by the computer according to claim 10, further comprising,
executing checkout processing, based on the purchase product information acquired by use of the checkout processing information.

16. The checkout assistance method executed by the computer according to claim 15, further comprising,
acquiring product image data of the purchase product indicated by the purchase product information acquired by use of the checkout processing information, and outputting the product image data onto a screen of the checkout processing apparatus.

17. The checkout assistance method executed by the computer according to claim 15, further comprising,
transmitting electronic receipt information based on the purchase product information to the mobile terminal, in response to completion of the checkout processing.

18. The checkout assistance method executed by the computer according to claim 10, further comprising,
generating screen data including, as the checkout processing information, a code symbol encoding the purchase product information.

19. A non-transitory computer readable medium storing a program that causes a computer to execute a checkout assistance method, the method comprising:
generating purchase product information relating to a purchase product of a customer read by use of a mobile terminal of the customer; and
generating screen data including checkout processing information for causing a checkout processing apparatus that executes checkout processing to acquire the purchase product information; and
outputting the screen data to a display of the mobile terminal.
